(19) United States
(12) Patent Application Publication
(10) Pub. No.: US 2006/0157582 A1
(43) Pub. Date: Jul. 20, 2006

(54) Fuel injector reducing stress concentration

(75) Inventors: Senta Tojo, Nagoya-city (JP); Yoshiro Shogaki, Yokkaichi-city (JP); Manabu Inaba, Handa-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/330,120

(22) Filed: Jan. 12, 2006

(30) Foreign Application Priority Data
Jan. 14, 2005 (JP) 2005-7695

(51) Int. Cl. F02M 41/16

(52) U.S. Cl. 239/96; 239/88; 239/585.1

(57) ABSTRACT

On an inner wall of a bag-shaped hole portion of a nozzle body, a cross angle between the bag-shaped hole portion and a needle hole or an oblique high-pressure fuel passage of the nozzle body is made obtuse, i.e. at 90 degrees or larger, through an electrochemical machining process with a suitably-shaped electrode or through after-processing with a boring tool having a predetermined shape. The center of the bag-shaped hole portion may be deviated toward the high-pressure fuel passage or the high-pressure fuel passage may be connected to a maximum diameter portion of the bag-shaped hole portion to provide the obtuse cross angle. Thus, excessive stress on the inner wall of the bag-shaped hole portion or a breakage of the nozzle body due to a crack can be inhibited.

### CROSS REFERENCE TO RELATED APPLICATION

This application is based on and incorporates herein by reference Japanese Patent Application No. 2005-7695 filed on Jan. 14, 2005.

### BACKGROUND OF THE INVENTION

1. Field of the Invention

The present invention relates to a fuel injector injecting high-pressure fuel, which is pressurized by a high-pressure supply pump and stored under pressure in a common rail, into a combustion chamber of an internal combustion engine.

2. Description of Related Art

A fuel injector is used in an accumulator fuel injection apparatus of a diesel engine or the like and injects high-pressure fuel supplied from a common rail into a combustion chamber of the engine. The fuel injector has an injector body equipped with an injection nozzle located on a front end side thereof, a drive device such as an electromagnetic valve located on a rear end side of the injector body and the like. The drive device receives a control signal from an engine control unit (ECU) to move a control piston located in the injector body and a needle valve located in the injection nozzle, thus opening or closing a fuel injection bore of the injection nozzle. The opening/closing control adjusts a quantity and injection timing of injection fuel injected from the injection nozzle in accordance with an engine operating condition.

The injector body has a valve body. The valve body is formed in a bar shape and is formed with a cylinder penetrating through its axial center. The valve body is formed with a high-pressure fuel passage and a low-pressure fuel passage in parallel with the cylinder. The injection nozzle is coaxially joined and screwed by a retaining nut to a front end of the valve body to form an injector body section. The drive device is located on a rear side of the valve body. A front end face of the valve body and a rear end face of the injection nozzle are joined by pressure welding for forming metal sealing, thus providing sealing of the high-pressure fuel flowing in the high-pressure fuel passage.

The injection nozzle has a nozzle body formed with a needle hole at the axial center thereof and a needle valve located in the needle hole movably upward and downward therein. The nozzle body has a rear portion with a large diameter equipped with a rear end face joined to a front end face of the injector body and a nozzle with a small diameter on a front side. The needle hole is formed along the axial center of the nozzle body. A bag-shaped hole portion with a large diameter is formed in an intermediate position of the needle hole between the rear portion and the front end side. A high-pressure fuel bore communicating coaxially with the high-pressure fuel passage of the valve body is formed in the rear end face with the large diameter. An oblique high-pressure fuel passage is formed between the high-pressure fuel bore and the bag-shaped hole portion, penetrating through the rear portion.

As shown in FIG. 9, the bag-shaped hole portion 45C is usually formed by an electrochemical machining process. As shown in FIG. 9, in the electrochemical machining process, a hollow electrode bar (cathode) G with a collar portion G1 molded in a predetermined shape at a front end (lower end in FIG. 9) is inserted into the needle hole 45, and a direct current voltage is applied while injecting electrolysis solution at a high speed from a hollow portion G2 of the electrode bar. Thus, a work portion (anode) is electrolyzed and removed. A quantity removed by the electrolyzing depends on current density or a flow rate of the electrolysis solution. In the electrochemical machining process, a diameter d1 of the collar portion G1 is limited by a diameter d2 of the needle hole 45. Therefore, the maximum diameter D of the bag-shaped hole portion 45C is generally twice the diameter d1 at work depth as feeding limit of the electrode. The electrochemical machining process is suitable for processing a material hard to chip such as a nozzle body 48, having high hardness and strength and disfavoring an affected layer or an inner surface of a closed bag-shaped hole or a three dimensional curved surface. However, working accuracy will deteriorate if working efficiency is improved.

A shape of the processed bag-shaped hole portion 45C is a pyriform close to a sphere. In the conventional fuel injector shown in FIG. 9, cross angles α1, α2 of connections between the bag-shaped hole portion 45C and the high-pressure fuel passage 46 and a cross angle α3 of a connection between the needle hole 45 and the bag-shaped hole portion 45C tend to be acute.

Recently, a pressure of high-pressure fuel is 200 MPA or higher. A fuel pressure inside the bag-shaped hole portion is a high pressure corresponding to this pressure. Radial compression stress and circumferential tensile stress are generated in a thick portion of the cylindrical nozzle body in proportion to an inner pressure in the needle hole. The circumferential tensile stress becomes the maximum at an inner periphery (inner wall). If the circumferential tensile stress exceeds tensile strength of a nozzle body material, yield will occur on the inner wall, first. If the inner pressure further increases, an outer wall will become subject to plastic deformation and will be broken. The tensile stress on the inner periphery increases as an internal diameter thereof increases. Therefore, it is advantageous to reduce a diameter of the needle hole in terms of pressure resistance. However, even in the case where the diameter of the needle hole is small, if a micro crack, a notch, or a protrusion exists on the inner wall of the needle hole, stress concentration can be applied thereto. In such a case, pressure-resistant strength of the cylinder will be largely deteriorated, and a breakage can be caused.

The conventional bag-shaped hole portion with the large diameter has a thick cylindrical outer periphery and is connected with the oblique cylindrical high-pressure fuel passage to form a substantially elliptic opening therebetween. The cross portion between the bag-shaped hole portion and the high-pressure fuel passage corresponds to the notch and is subject to the stress concentration, thus easily producing excessive stress. A magnitude of the stress concentration depends greatly on a tip end angle of the notch. As the cross angle between the bag-shaped hole portion and the high-pressure fuel passage becomes sharper, the stress concentration increases, leading to easier generation of the excessive stress.

A crack due to excessive stress is generated more easily as the fuel pressure increases. The crack can raise the problems of breakage or durability deterioration of the nozzle body.

Aiming to inhibit durability deterioration of the nozzle body, U.S. Pat. No. 6,651,911 describes bending the high-pressure fuel passage near the bag-shaped hole portion, thereby forming an obtuse cross angle. However, in this structure, the nozzle body needs to be divided. Accordingly, another problems that the construction becomes complicated and also the high-pressure fuel easily leaks from a sealing face will be raised.

### SUMMARY OF THE INVENTION

It is therefore an object of the present invention to provide a reliable fuel injector with a nozzle body that inhibits excessive stress and that has excellent durability under high-pressure fuel.

According to an aspect of the present invention, a fuel injector includes an injector body connected with an injection nozzle at a front end of the injector body and a drive device located on a rear side of the injector body. The injector body includes a valve body that is formed with a cylinder in a center thereof and that is formed with a first high-pressure fuel passage and a low-pressure fuel passage in parallel with the cylinder. The injection nozzle is formed with a needle hole and a high-pressure fuel bore communicating concentrically with the cylinder and the first high-pressure fuel passage respectively and is joined coaxially with the valve body. The injection nozzle includes a nozzle body having a rear portion, which has a large diameter and a rear end face joined to the valve body, and a nozzle with a small diameter on a front end side thereof and a needle valve located in the needle hole. The nozzle body is formed with a bag-shaped hole portion with a large diameter in an intermediate portion at the axial center of the nozzle body and with an injection bore in a front end portion of the nozzle body. The nozzle body is formed with a second high-pressure fuel passage through which the high-pressure fuel flows from the high-pressure fuel bore to the bag-shaped hole portion. The second high-pressure fuel passage and the bag-shaped hole portion provide a cross angle of 90 degrees or larger at a connection therebetween.

Recently, a pressure of high-pressure fuel is 200 MPA or higher due to a demand for accuracy of fuel injection control and atomization of sprayed fuel. As a result, problems such as a breakage or durability deterioration of a nozzle body due to excessive stress occur at a cross connection between a high-pressure fuel passage and a bag-shaped hole portion of a nozzle body. Generally, if a high pressure is applied to an inside of a single hole, a circumferential tensile stress increases as an internal diameter is increased. If another hole penetrates through the inner wall of the single hole, the circumferential tensile stress in the cross hole portion increases further even under the same inner pressure therein in the case of the single hole. It is because stress concentration is applied to the cross hole portion. A stress concentration coefficient largely changes depending on an angle of the cross front end of the cross hole. It can be assumed that the stress concentration increases and the circumferential tensile stress becomes excessive if the cross angle is acute. It can be assumed that the stress concentration can be alleviated and the circumferential tensile stress can be reduced if the cross angle is obtuse.

A table of FIG. 8 shows a result of stress simulation in a simple model having a single hole (first model, left) and another simple model having a cross hole in addition to the first hole (second model, right). In the table shown in FIG. 8, the maximum stress at the hole in the first model is plotted, and also, the maximum stresses at the cross portion between the first hole and the cross hole in the case where the cross angle α is changed from acute angles to obtuse angles are plotted. According to the result, it is found that the stress is increased due to the presence of the cross hole compared to the case of the single hole. The stress increases excessively if the cross angle is reduced to an acute angle, i.e. less than 90 degrees. The stress is small when the cross angle is obtuse, i.e. more than 90 degrees, thereby restraining a stress increase effectively.

Accordingly, the cross angle formed in the bag-shaped hole portion with the large diameter under high-pressure fuel should be preferably set as obtuse as possible. Specifically, a cross angle equal to 90 degrees or over is suitable.

Thus, stress concentration in the connection cross portion between the high-pressure fuel passage and the bag-shaped hole portion can be alleviated even under high tensile stress since the cross angle is obtuse. As a result, excessive stress can be inhibited.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a cross-sectional view showing a fuel injector according to a first example embodiment of the present invention;

FIG. 2 is an enlarged cross-sectional view showing a nozzle body according to the FIG. 1 embodiment;

FIG. 3A is an enlarged cross-sectional view showing a bag-shaped hole portion according to the FIG. 1 embodiment;

FIG. 3B is a processing explanation view according to the FIG. 1 embodiment;

FIG. 4A is an enlarged cross-sectional view showing a bag-shaped hole portion according to a second example embodiment of the present invention;

FIG. 4B is a processing explanation view according to the FIG. 4A embodiment;

FIG. 5A is an enlarged cross-sectional view showing a bag-shaped hole portion according to a third example embodiment of the present invention;

FIG. 5B is a processing explanation view according to the FIG. 5A embodiment;

FIG. 6 is an enlarged cross-sectional view showing a bag-shaped hole portion according to a fourth example embodiment of the present invention;

FIG. 7 is an enlarged cross-sectional view showing a bag-shaped hole portion according to a fifth example embodiment of the present invention;

FIG. 8 is a table showing calculation results of maximum stress at holes; and

FIG. 9 is a processing explanation view of a bag-shaped hole portion of a related art.

### DETAILED DESCRIPTION OF EXAMPLE EMBODIMENTS

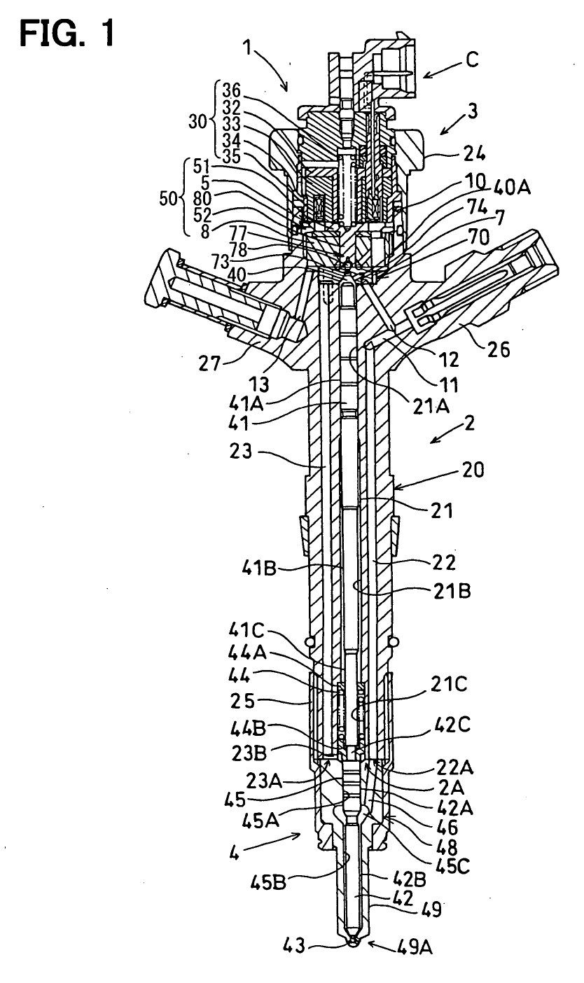

Referring to FIG. 1, an electromagnetically controlled type fuel injector (such as piezo type fuel injector) 1 that intermittently injects fuel into a combustion chamber of an engine is illustrated. The fuel injector 1 is used in an accumulator type (common rail type) fuel injection apparatus for a diesel engine and injects high-pressure fuel supplied from the common rail (not shown) into the combustion chamber of the engine. The injector 1 has an injector body 2, an electromagnetic valve 3 mounted to an upper end side of the injector body 2 and a fuel injection nozzle 4 fixed to a lower end side of the injector body 2.

The electromagnetic valve 3 has a connector C connected to a wiring harness extending from an engine control unit (ECU) (not shown). The electromagnetic valve 3 is controlled by a control signal output from the ECU.

The injector body 2 has a valve body 20 formed in a bar shape. The valve body 20 is formed with a cylinder 21 penetrating through an axial center and is formed with a high-pressure fuel passage 22 and a low-pressure fuel passage 23 in parallel with the cylinder 21. A cylindrical electromagnetic valve location chamber 10 is formed on an upper end side of the valve body 20. The electromagnetic valve 3 is mounted and threaded to the electromagnetic valve location chamber 10 through a retaining nut 24. The injection nozzle 4 is coaxially joined and fastened to a lower end of the valve body 20 through a retaining nut 25. A cylindrical inlet portion 26 and a cylindrical outlet portion 27 are formed at an upper portion of the valve body 20 to be inclined in upward directions.

The electromagnetic valve 3 has an electromagnetic solenoid 30 located in an upper portion of the electromagnetic valve location chamber 10 and a valve opening/closing mechanism 50 located in a lower portion of the electromagnetic valve location chamber 10. The valve opening/closing mechanism 50 includes a moving member 5 and a moving-member holder 8 holding the moving member 5.

A plate chamber 70 with a small diameter is formed on a lower side of the moving-member holder 8 (in the lower end portion of the electromagnetic valve location chamber 10). A disc-shaped orifice plate 7 is received in the plate chamber 70.

The electromagnetic solenoid 30 is so constructed that a magnetic core 33 made of a compound magnetic material is located around an outer periphery of an upper-end collar cylinder 32 made of ferromagnetic material, the outer periphery of the magnetic core 33 is surrounded by a ferromagnetic outer tube 34 and an electromagnetic coil 35 is located in the magnetic core 33. A lower face of the electromagnetic solenoid 30 is an attraction face of the moving member 5 and a lower end face of the cylinder 32 is a stopper face with which the moving member 5 collides (contacts).

A high-pressure fuel inflow passage 11 communicating with the high-pressure fuel passage 22 and an inlet passage 12 connecting the high-pressure fuel inflow passage 11 with the plate chamber 70 are formed inside the inlet portion 26. An outflow passage 13 connected to the low-pressure fuel passage 23 via the plate chamber 70 is formed in the outlet portion 27 to form a discharge passage for discharging extra fuel in the fuel injector 1 to an exterior.

A conical concave portion is formed on a lower face of the orifice plate 7 to form a pressure control chamber 40. An outlet orifice 73 is formed in the upper face of the control chamber 40 at the center thereof. An oblique communicating bore 40A opens in a conical oblique face of the pressure control chamber 40. The oblique communicating bore 40A communicates in its lower face with the inlet passage 12 of the inlet portion 26 via an inlet orifice 74.

Fuel pressure of the high-pressure fuel supplied from the common rail is introduced to the pressure control chamber 40 via the high-pressure fuel inflow passage 11, the inlet passage 12 and the inlet orifice 74.

The moving member 5 includes a flat portion 51 and a shaft portion 52. The flat portion 51 is located in a moving chamber 80. The moving-member holder 8 is cylindrical. The shaft portion 52 is slidably fit into a central hole of the moving-member holder 8. A top face of the flat portion 51 is flat and is an attracted face attracted to the bottom face of the electromagnetic solenoid 30. The moving-member holder 8 is threaded to an inner periphery of the electromagnetic valve location chamber 10.

The shaft portion 52 is columnar. A valve body chamber 77 formed of a cylindrical portion and a conical portion is formed in the center of the lower end face of the shaft portion 52. A ball valve 78 made of silica nitride is received in the valve body chamber 77. The ball valve 78 has a spherical upper face and a sealing flat lower face that closes the outlet orifice 73 in the upper face of the orifice plate 7. The moving member 5 is biased downward (in closing direction) by a spring 36 located inside the upper-end collar cylinder 32 and is attracted upward (in opening direction) by a magnetic force generated by the electromagnetic solenoid 30, thus moving upward and downward.

The electromagnetic valve location chamber 10 accommodating the moving chamber 80, the electromagnetic solenoid 30 including the upper-end collar cylinder 32 and the valve opening/closing mechanism 50 communicates with the outflow passage 13 connected to the low-pressure fuel passage 23 and is filled with low-pressure fuel oil. Therefore, the upward/downward movement of the moving member 5 generates resistance of the low-pressure fuel oil at the flat portion 51, thereby affecting responsiveness of the electromagnetic valve 3.

An impact is applied to the moving member 5 when it moves upward and downward. Therefore, the moving member 5 is also an important portion from a viewpoint of durability. A suitable shape of the moving member 5 is adopted in consideration of this.

The cylinder 21 penetrates through the center of the valve body 20. The cylinder 21 includes a sliding portion 21A, a pressure-receiving portion 21B and a spring-receiving portion 21C, which are slightly different in internal diameter from each other, and receives a control piston 41.

The control piston 41 is a cylindrical, upward/downward moving piston formed of a sliding portion 41A, a pressure-receiving portion 41B and a spring portion 41C corresponding to the structure of the cylinder 21. The upper end of the control piston 41 is formed in a conical, trapezoidal shape to form a suitable clearance (space) in the pressure control chamber 40 formed in the orifice plate 7. The control piston 41 is pushed downward in response to pressure in the pressure control chamber 40 and moves with the sliding portion 41A sliding. A flat face of the lower end of the control piston 41 contacts the upper end portion of a needle valve 42 received in the injection nozzle 4.

The high-pressure fuel passage 22 communicating with the high-pressure fuel inflow passage 11 of the inlet portion 26 is independently formed in parallel with the cylinder 21 in the valve body 20 and opens in the lower end face of the valve body 20 to form a high-pressure fuel bore 22A.

The low-pressure fuel passage 23 communicating with the outflow passage 13 of the outlet portion 27 is independently formed in parallel with the cylinder 21 in a position substantially opposite to the high-pressure fuel passage 22 across the cylinder 21. The low-pressure fuel passage 23 opens in the lower end face of the valve body 20 to form a low-pressure fuel bore 23A. A low-pressure fuel communicating groove 23B extending toward the center of the cylinder 21 is further formed in the low-pressure fuel bore 23A to communicate with an inside of the cylinder 21.

The lower end face of the valve body 20 including the high-pressure fuel bore 22A, the low-pressure fuel bore 23A and the low-pressure fuel communicating groove 23B constitutes an even front end face 2A, which contacts a rear end face of the injection nozzle 4 to form a metal sealing face.

A spring seat 44A and a bearing seat 44B, as well as a spring 44 are interposed in the spring-receiving portion 21C of the cylinder 21 opening in the lower end face of the valve body 20.

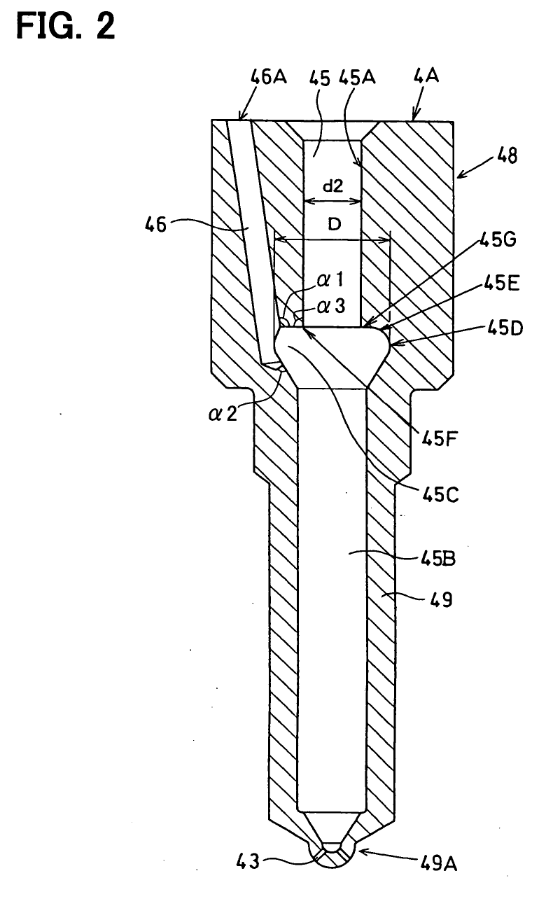

The injection nozzle 4 includes a nozzle body 48 shown in FIG. 2. The nozzle body 48 includes a rear portion with a large diameter and a nozzle 49 with a small diameter, thus forming a two-step cylindrical shape. The retaining nut 25 is engaged to the step portion and is screwed to a threaded portion formed on a lower-end outer portion of the valve body 20 to generate an axial force, i.e. a sealing pressure.

A needle hole 45 and a high-pressure fuel passage 46 are formed in the rear end face of the nozzle body 48 to communicate concentrically with the cylinder 21 and the high-pressure fuel passage 22 of the valve body 20 respectively. One end of the high-pressure fuel passage 46 opens in the rear end face of the nozzle body 48 to form a high-pressure fuel bore 46A. The other end penetrates obliquely to a bag-shaped hole portion 45C with a large diameter formed in an intermediate position of the needle hole 45.

The rear end face of the nozzle body 48 including the high-pressure fuel bore 46A constitutes an even flat face 4A and contacts the front end face 2A of the valve body 20 to form a metal sealing face.

The needle hole 45 receiving the needle valve 42 at its center is formed with a sliding portion 45A and a fuel passage 45B, which are slightly different in internal diameter from each other. The bag-shaped hole portion 45C having a large volume with a large diameter is formed upstream of the fuel passage 45B and communicates with the high-pressure fuel passage 46.

A nozzle front end chamber 49A having a suitably thin, tapered structure for blocking the lower end of the needle hole 45 is formed downstream of the fuel passage 45B. One or a suitable number of injection bores 43 are located in appropriate positions in the nozzle front end chamber 49A, thus spraying high-pressure fuel.

Usually, as shown in FIG. 9, a bag-shaped hole portion 45C is formed by an electrochemical machining process, in which a hollow electrode bar G with a collar portion G1 at its front end (lower end in FIG. 9) is inserted into the needle hole 45, and electrolysis solution is injected from a hollow portion G2. Since a diameter d1 of the collar portion G1 is limited by a diameter d2 of the needle hole 45 in a conventional electrochemical machining process, the maximum diameter D of the bag-shaped hole portion 45 C is limited to approximately twice the diameter d1 of the needle hole 45. As a result, a shape of the processed bag-shaped hole portion is a pyriform close to a sphere. In this fuel injector, cross angles α1, α2 of connections between the bag-shaped hole portion 45C and the high-pressure fuel passage 46 and a cross angle α3 of a connection between the needle hole 45 and the bag-shaped hole portion 45C tend to be acute as shown in FIG. 9. This affects stress concentration of the inner tensile stress, thus deteriorating durability.

The shape of the bag-shaped hole portion formed by the electrochemical machining process of injecting electrolysis solution with a normal electrode bar is a pyriform close to a sphere. Accordingly, in many cases of using this electrochemical machining process, the cross angle between the bag-shaped hole portion 45C and the high-pressure fuel passage 46 or the needle hole 45 is finished to be acute.

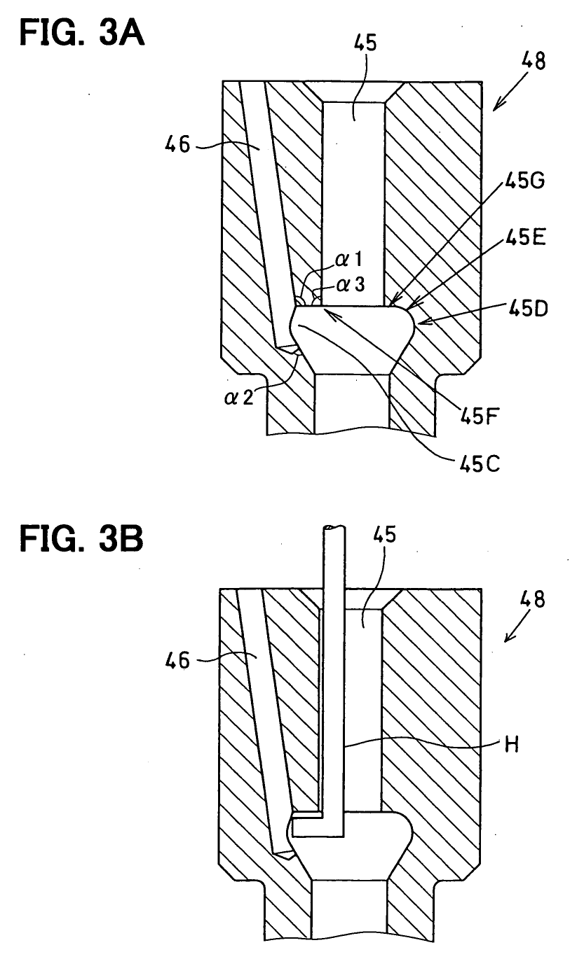

Therefore, in the present embodiment, as shown in FIGS. 3A and 3B, as after-processing, the cross angle α1 between the high-pressure fuel passage 46 and the bag-shaped hole portion 45C is finished to be obtuse or the cross angle α3 between the needle hole 45 and the bag-shaped hole portion 45C is finished to be about 90 degrees by a cutting process or an electric discharge machining process.

In this example embodiment, as shown FIG. 3B, the cross portion between the bag-shaped hole portion 45C and the needle hole 45 is cut so that the cross portion has substantially the right angle by using a boring tool H having an L-shaped front end of substantially the right angle. A shoulder 45E existing above a maximum diameter portion 45D inside the bag-shaped hole portion 45C is bored circumferentially such that the shape is changed from the pyriform into a substantially reverse conical trapezoid. Thus, the cross angle between the bag-shaped hole portion 45C and the high-pressure fuel passage 46 is made obtuse, aiming to alleviate stress concentration. The cutting process is performed by rotating the tool H or the work piece. A rotation center of the tool H is slightly deviated from a center of the needle hole 45 toward the high-pressure fuel passage 46 (left side in FIG. 3B) to process only the shoulder 45E within the requisite minimum. Attention should be paid to generation of cutting burrs. However, the boring process requires just a small cutting amount, generating just a small amount of the cutting burrs.

An electric discharge machining process with an electrode in place of the cutting tool is also suitable. The electric discharge machining process requires a longer time. However, the electric discharge machining process is advantageous in terms of prevention of burrs and is suitable for complicated shapes (three dimensional curve surface) or for accuracy improvement. These processes can be selectively used for a desired shape setting.

Thus, the cross angle between the bag-shaped hole portion 45C and the needle hole 45 or the high-pressure fuel passage 46 can be made an obtuse angle of substantially 90 degrees or over. Accordingly, concentration of the tensile stress due to the inner pressure to the inner periphery can be alleviated and generation of excessive stress can be inhibited.

Further, in the after-processing such as the cutting process or the electric discharge machining process, the cross portion between the needle hole 45 and the bag-shaped hole portion 45C can be easily processed to be a round corner by forming the boring tool H or the electric discharge electrode to be a predetermined shape for a round corner or burr removal, for example. As a result, the round corner can alleviate micro stress concentration. Use of the obtuse shape and the round corner shape alleviates the stress concentration.

The needle valve 42 is substantially in a cylindrical shape corresponding to the shape of the needle hole 45 and includes a sliding portion 42A slidably held and a needle portion 42B with a slightly smaller diameter constituting a pressure-receiving step. A front end of the needle portion 42B includes a needle valve structure having a suitable conical face. The needle valve 42 moves upward or downward, thereby opening/closing the injection bore 43 of the nozzle front end chamber 49A having a tapered structure. On the upper end of the needle valve 42, a contact convex portion 42C with a smaller diameter than the sliding portion 42A is mounted to the bearing seat 44B and holds concentrically the spring 44. The needle valve 42 is biased downward (in direction for closing the injection bore 43) by the spring 44. Note that the contact convex portion 42C may be formed on a lower end of the control piston 41 and either construction may be adopted as long as the contact convex portion 42C is mounted to the bearing seat 44B to hold concentrically the spring 44 and to securely support the biasing force.

The needle valve 42 moves upward/downward depending on the balance between downward biasing forces of a fuel pressure in the pressure control chamber 40 and a spring load of the spring 44 and upward biasing force applied to the needle valve 42 by a fuel pressure in the injection nozzle 4, thus opening/closing the injection bore 43. If the pressure in the pressure control chamber 40 decreases, the control piston 41 and the needle valve 42 move upward to open the injection bore 43. Thus, the high-pressure fuel supplied from the high-pressure fuel passage 22 to the injection nozzle 4 is injected into the combustion chamber.

Operations of the fuel injector 1 of this example embodiment will be explained with reference to FIGS. 1 to 3B.

In the fuel injector 1, if the electromagnetic solenoid 30 is energized, the moving member 5 is attracted by the electromagnetic force and moves upward. Thus, a toric contact flat face of the moving member 5 collides with a lower face (stopper face) of the cylinder 32, and the moving member 5 stops. The ball valve 78 moves upward in association with the moving member 5 to open the outlet orifice 73. Thus, the outlet orifice 73 communicates with the outflow passage 13 of the low-pressure fuel. Accordingly, the pressure in the pressure control chamber 40 instantaneously decreases to break the pressure balance applied to the control piston 41 inside the cylinder 21. Thus, the control piston 41 moves upward and as a result, the needle valve 42 inside the needle hole 45 moves upward due to the high-pressure fuel pressure in the bag-shaped hole portion 45C. The high-pressure fuel from the bag-shaped hole portion 45C is sprayed from the opened injection bore 43. At this time, the fuel supplied at high pressure from the high-pressure fuel passage 46 to the bag-shaped hole portion 45C smoothly flows without contraction or separation because the cross angles are obtuse. An appropriate quantity of the high-pressure fuel can be supplied into the injection bore 43 without generating concentration of tensile stress due to the high pressure. As a result, deterioration of an engine performance or durability of the injection nozzle 4 can be inhibited. If the electromagnetic solenoid 30 is deenergized, the moving member 5 moves downward due to the biasing force and the ball valve 78 closes the outlet orifice 73. The pressure of the high-pressure fuel is applied to the pressure control chamber 40 from the inlet orifice 74 to move the control piston 41 downward. Likewise, the needle valve 42 moves downward. Thus, the injection bore 43 is closed to finish the fuel injection.

As explained above, the fuel injector 1 of this example embodiment has the injector body 2 and the electromagnetic valve 3. The injector body 2 is connected to the injection nozzle 4 at the front end thereof. The electromagnetic valve 3 is located on the rear side of the injector body 2. The injector body 2 includes the valve body 20, in which the cylinder 21 is formed in the center and the high-pressure fuel passage 22 and the low-pressure fuel passage 23 are formed in parallel with the cylinder 21. The injection nozzle 4 is formed with the needle hole 45 and the high-pressure fuel bore 46A communicating concentrically with the cylinder 21 and the high-pressure fuel passage 22 respectively. The injection nozzle 4 is joined coaxially to the valve body 20 through the retaining nut 25. The injection nozzle 4 includes the nozzle body 48 and the needle valve 42. The nozzle body 48 has the rear portion with the enlarge diameter equipped with the rear end face joined to the valve body 20 and the nozzle 49 with the small diameter on the front end side. The nozzle body 48 is formed with the bag-shaped hole portion 45C with the large diameter in the intermediate portion at the axial center and the needle hole 45 having the injection bore 43 at the front end portion. The needle valve 42 is located in the needle hole 45. The nozzle body 48 is formed with the high-pressure fuel passage 46 introducing the high-pressure fuel from the high-pressure fuel bore 46A to the bag-shaped hole portion 45C of the nozzle body 48. The cross angle of the connection between the high-pressure fuel passage 46 and the bag-shaped hole portion 45C is set at 90 degrees or larger.

In the above structure, stress concentration at the cross connection between the high-pressure fuel passage 46 and the bag-shaped hole portion 45C can be alleviated even under high tensile stress since the cross angle is obtuse. As a result, generation of excessive stress can be inhibited.

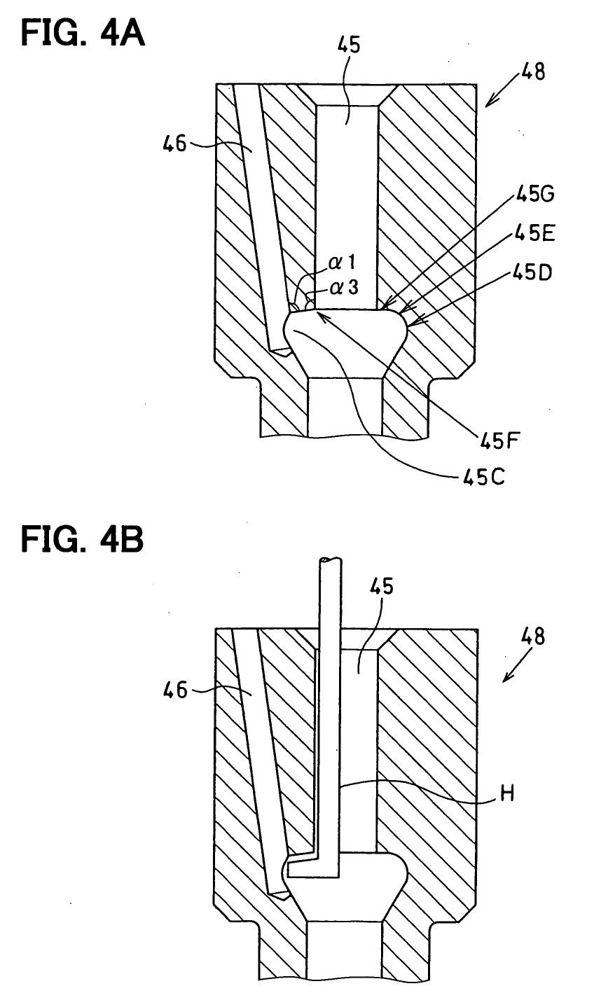

Referring to FIG. 4A, a bag-shaped hole portion 45C according to a second example embodiment of the present invention is illustrated.

Usually, the bag-shaped hole portion 45C formed by an electrochemical machining process of injecting electrolysis solution with a normal electrode bar is finished in a pyriform shape. As shown in FIG. 9, in many cases of using this electrochemical machining process, the cross angle between the bag-shaped hole portion 45C and the high-pressure fuel passage 46 or the needle hole 45 is finished to be acute.

In contrast, in an example of after-processing shown in FIG. 4A, the cross angle α3 between the needle hole 45 and the bag-shaped hole portion 45C is finished to be obtuse (at 90 degrees or larger) by a cutting process or an electric discharge machining process.

In this example embodiment, as shown FIG. 4B, the cross portion between the bag-shaped hole portion 45C and the needle hole 45 is bored by using a boring tool H with the obtuse L-shaped front end. A shoulder 45E above the maximum diameter portion 45D inside the bag-shaped hole portion 45C is bored in the circumferential direction to such extent as to change the pyriform shape of the bag-shaped hole portion 45C into an abacus bead-shape. Thus, the cross angle between the bag-shaped hole portion 45C and the needle hole 45 is finished to be obtuse (at 90 degrees or larger), aiming to alleviate stress concentration. The boring tool H is used for performing a cutting process by rotating the tool H or a work piece while the rotation center of the tool H is slightly deviated from the center of the needle hole 45 toward the high-pressure fuel passage 46 (leftward in FIG. 4B). Thus, only the shoulder 45E within the requisite minimum is processed. Attention should be paid to generation of cutting burrs. However, the boring process cuts only a small amount and generates just a small amount of cutting burrs.

In addition to the cutting process with the cutting tool, an electric discharge machining process with an electrode is also suitable. The electric discharge machining process requires a longer period but is advantageous in terms of prevention of burrs. The electric discharge machining process can be suitably applied to complicated shapes (three dimensional curve surface) and can improve accuracy. These processes can be selectively used for a desired shape setting.

Stress can be easily concentrated at a convex portion 45F that is formed at a step between the inner peripheries of the needle hole 45 with the small diameter and the bag-shaped hole portion 45C with the large diameter and protrudes due to a difference in the inner diameters. Therefore, in this example embodiment, the tip end of the convex portion 45F is made obtuse to alleviate the stress concentration, suppressing generation of excessive stress.

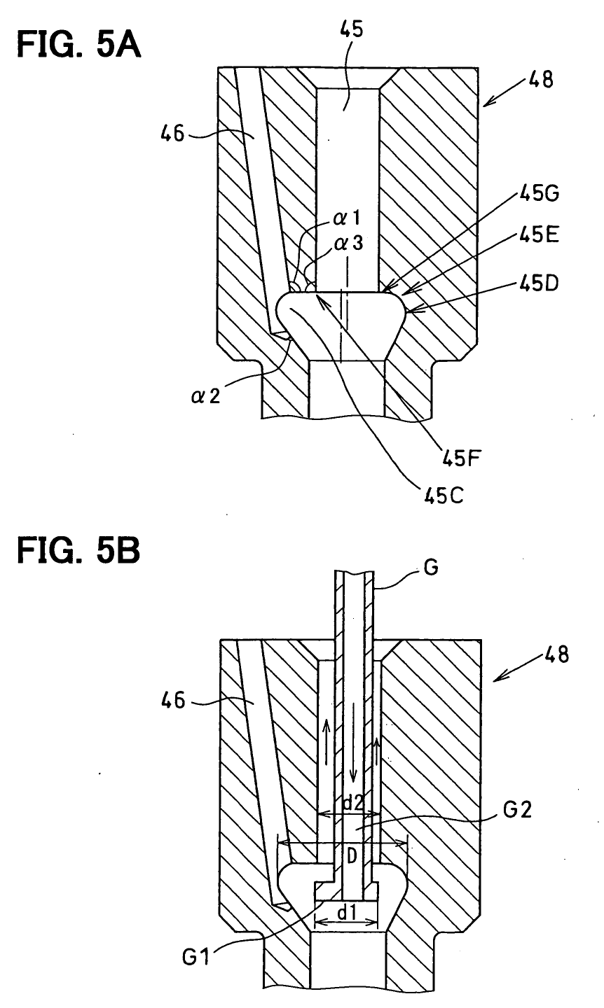

Referring to FIG. 5A, a bag-shaped hole portion 45C according to a third example embodiment of the present invention is illustrated. In this example embodiment, the bag-shaped hole portion 45C is processed with a special electrode bar G having an eccentric collar portion G1 through a normal electronic discharge machining process without additional after-processing as in the first or second example embodiment. Thus, the axial center of the bag-shaped hole portion 45C is offset toward the high-pressure fuel passage 46 from the axial center of the needle hole 45.

As shown in FIG. 5B, the bag-shaped hole portion 45C is formed by an electrochemical machining process, in which the hollow electrode bar G having the eccentric collar portion G1 at the front end is inserted into the needle hole 45 and electrolysis solution is injected through the hollow portion G2. In this electronic discharge machining process, a diameter d1 of the collar portion G1 is limited by a needle hole diameter d2. However, in regard to processing depth toward the high-pressure fuel passage 46, a feeding amount can be increased by an eccentric amount of the diameter d1 of the collar potion G1. The electrolysis can be promoted due to an increase of the flow of the electrolysis solution at the eccentric portion of the collar portion G1. Thus, the bag-shaped hole portion 45C eccentric toward the high-pressure fuel passage 46 can be formed. The maximum diameter D of the bag-shaped hole portion 45C is limited to about twice the diameter d1 like the first or second example embodiment, in which the bag-shaped hole portion is not eccentric. With this structure, the cross portion between bag-shaped hole portion 45C and the high-pressure fuel passage 46 defines a deep and extensive cross face. Accordingly, the cross angle α2 at the tip end of the high-pressure fuel passage 46 or the cross angle α1 at the shoulder 45E of the bag-shaped hole portion 45C can be made obtuse. The cross angle α3 at the needle hole 45 can be set at generally 90 degrees.

In the fuel injector 1 according to this example embodiment, the center of the bag-shaped hole portion 45C is deviated from the center of the needle hole 45 toward the high-pressure fuel passage 46. In this structure, the bag-shaped hole portion 45C can deeply cross with the oblique high-pressure fuel passage 46 just by deviating the center of the bag-shaped hole portion 45C by a necessary distance toward the high-pressure fuel passage 46 while the diameter of the bag-shaped hole portion 45C remains the same, without enlarging the diameter of the bag-shaped hole portion 45C or causing deterioration of pressure resistance. Accordingly, an upper-face flat portion 45G of the bag-shaped hole portion 45C can cross with the high-pressure fuel passage 46 so that the obtuse cross angle can be maintained. As a result, stress concentration can be alleviated and generation of excessive stress can be inhibited.

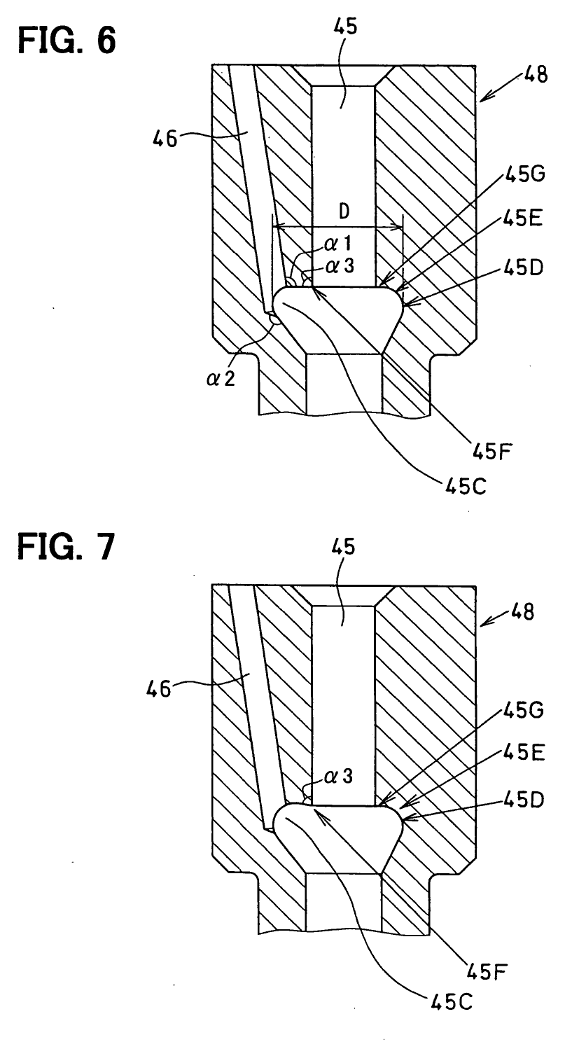

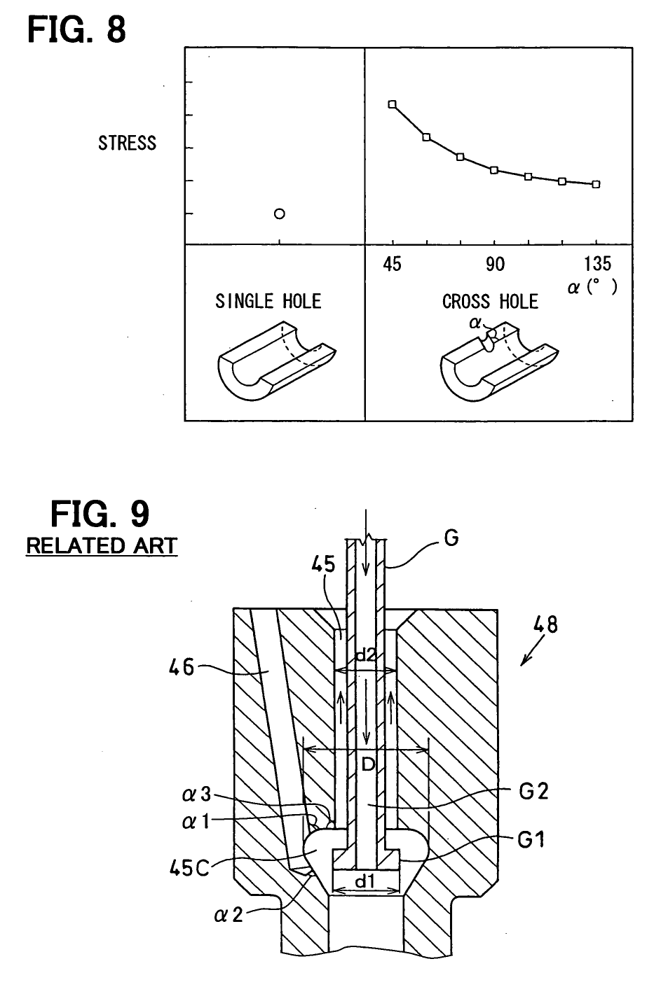

Referring to FIG. 6, a bag-shaped hole portion 45C according to a fourth example embodiment of the present invention is illustrated. In the fuel injector 1 of this example embodiment, the high-pressure fuel passage 46 communicates with the maximum diameter portion 45D of the bag-shaped hole portion 45C.

In the structure of this example embodiment, the high-pressure fuel passage 46 is connected with the maximum diameter portion 45D so that a central axis of the high-pressure fuel passage 46 substantially overlaps with a normal line of the deep maximum diameter portion 45D. Thus, a large connection area can be ensured and the cross angle can be maintained at substantially the right angle or larger. As a result, stress concentration can be alleviated and generation of excessive stress can be inhibited.

Referring to FIG. 7, a bag-shaped hole portion 45C according to a fifth example embodiment of the present invention is illustrated. In this example embodiment, the cross angle α3 between the bag-shaped hole portion 45C and the needle hole 45 is finished to be acute. The needle valve 42 is received in the needle hole 45 as shown in FIG. 1. The needle valve 42 is pushed upward by the high pressure in the bag-shaped hole portion 45C and is opened when the fuel is injected. At this time, the fuel pressure at the sliding portion 42a of the needle valve 42 is substantially reduced to an atmospheric pressure. Therefore, the pressure at the cross portion between the bag-shaped hole portion 45C and the needle hole 45 is lower than the pressure at the cross portion between the bag-shaped hole portion 45C and the high-pressure fuel passage 46. Since the diameter of the needle hole 45 is smaller the that of the bag-shaped hole portion 45C, the tensile stress generated in the inner periphery of the needle hole 45 is not large. Therefore, even if the cross angle α3 between the bag-shaped hole portion 45C and the needle hole 45 is acute, the influence of the stress concentration is not so large. Accordingly, even if the cross angle α3 between the bag-shaped hole portion 45C and the needle hole 45 is finished to be acute, generation of the crack is not caused by excessive stress in particular.

In the above example embodiments, the cross angle at the connection between the bag-shaped hole portion 45C and the high-pressure fuel passage 46 is set at 90 degrees or larger, and preferably, the cross angle at the cross portion between the bag-shaped hole portion 45C and the needle hole 45 is set at 90 degrees or larger. Stress concentration can be alleviated by forming a micro round corner or a micro round face for removing burrs at a tip end of the cross portion. The stress concentration can be alleviated further suitably by setting the cross angle of the connection between the bag-shaped hole portion 45C and the high-pressure fuel passage 46 at 90 degrees or larger in addition to forming the micro round corner or the round face for removal of burrs.

A round shape may be formed at the same time as the electrolysis discharge machining process by using a collar portion G1 of the electrode bar with a round shape. Predetermined processing for forming a round corner may be added as after-processing. Processing is not limited to theses processing methods as long as a round corner is easily formed and generation of a micro crack can be inhibited.

In the above example embodiments, the electromagnetic drive device is used. Other drive devices such as a piezo type drive device may be used. The drive device is not limited to these described devices as long as the device can open/close the needle valve 42.

The present invention should not be limited to the disclosed embodiments, but may be implemented in many other ways without departing from the spirit of the invention.

What is claimed is:

1. A fuel injector comprising:
an injector body connected with an injection nozzle at a front end of the injector body; and
a drive device located on a rear side of the injector body, wherein:
the injector body includes a valve body that is formed with a cylinder in a center thereof and that is formed with a first high-pressure fuel passage and a low-pressure fuel passage in parallel with the cylinder,
the injection nozzle is formed with a needle hole and a high-pressure fuel bore communicating concentrically with the cylinder and the first high-pressure fuel passage respectively and is joined coaxially with the valve body,
the injection nozzle includes a nozzle body having a rear portion, which has a large diameter and a rear end face joined to the valve body, and a nozzle with a small diameter on a front end side thereof and a needle valve located in the needle hole, the nozzle body being formed with a bag-shaped hole portion with a large diameter in an intermediate portion at the axial center of the nozzle body and with an injection bore in a front end portion of the nozzle body,
the nozzle body is formed with a second high-pressure fuel passage through which the high-pressure fuel flows from the high-pressure fuel bore to the bag-shaped hole portion, and
the second high-pressure fuel passage and the bag-shaped hole portion provide a cross angle of 90 degrees or larger at a connection therebetween.

2. The fuel injector according to claim 1, wherein the needle hole and the bag-shaped hole portion provide a cross angle of 90 degrees or larger at a connection therebetween.

3. The fuel injector according to claim 1, wherein a center of the bag-shaped hole portion is deviated from a center of the needle hole toward the second high-pressure fuel passage.

4. The fuel injector according to claim 1, wherein the second high-pressure fuel passage is connected to a portion of the bag-shaped hole portion where a diameter of the bag-shaped hole portion is the largest.

5. The fuel injector according to claim 4, wherein a center of the second high-pressure fuel passage substantially overlaps with a normal line of the portion of the bag-shaped hole portion where the diameter of the bag-shaped hole portion is the largest.
